(19) United States
(12) Patent Application Publication
(10) Pub. No.: US 2025/0034840 A1
(43) Pub. Date: Jan. 30, 2025

(54) CAB AND WORK MACHINE

(71) Applicant: KOMATSU LTD., Minato-ku, Tokyo (JP)

(72) Inventors: Satoshi NAKAGAWA, Minato-ku, Tokyo (JP); Hirofumi WADA, Minato-ku, Tokyo (JP)

(73) Assignee: KOMATSU LTD., Minato-ku, Tokyo (JP)

(21) Appl. No.: 18/714,152

(22) PCT Filed: Nov. 8, 2022
(86) PCT No.: PCT/JP2022/041553

§ 371 Date: May 29, 2024

(30) Foreign Application Priority Data
Dec. 2, 2021 (JP) 2021-196010

(51) Int. Cl. E02F 9/20; E02F 9/16

(52) U.S. Cl. CPC E02F 9/2004; E02F 9/16

(57) ABSTRACT

A cab includes an operator's seat and a console. The console includes an operation unit and is located laterally of the operator's seat. The operation unit includes a first control lever and a second control lever. The second control lever is located between the operator's seat and the first control lever in a left-right direction. The first control lever includes a first knob. The second control lever includes a second knob. The first knob has a width larger than a width of the second knob as seen in a top view.

### TECHNICAL FIELD

The present disclosure relates to a cab and a work machine.

### BACKGROUND ART

WO2012/124767 (PTL 1) discloses a wheel loader including a vehicle body, a work implement, and a work implement control device. The work implement control device includes an arm control lever and a bucket control lever.

### CITATION LIST

### Patent Literature

PTL 1: WO2012/124767

### SUMMARY OF INVENTION

### Technical Problem

According to PTL 1, an operator holds one of the arm control lever and the bucket control lever with a hand. When the operator switches from operating one of the arm control lever and the bucket control lever to operating the other of the arm control lever and the bucket control lever, the operator needs to release the hand from the one of the arm control lever and the bucket control lever and hold the other of the arm control lever and the bucket control lever with this hand. Operators are therefore tend to be fatigued. It is an object of the present disclosure to provide a cab and a work machine that enable reduction of operators' fatigue.

### Solution to Problem

A cab of the present disclosure includes an operator's seat and a console. The console includes an operation unit and is located laterally of the operator's seat. The operation unit includes a first control lever and a second control lever. The second control lever is located between the operator's seat and the first control lever in a left-right direction. The first control lever includes a first knob. The second control lever includes a second knob. The first knob includes: a first upper curved portion located on an operator's seat side, which is a side located laterally of the operator's seat; and a second upper curved portion located on an opposite side to the operator's seat side, as seen in a rear view. The second knob includes a third upper curved portion located on the operator's seat side and a fourth upper curved portion located on the opposite side to the operator's seat side, as seen in the rear view. The first knob has a width larger than a width of the second knob as seen in a top view. The second upper curved portion is curved more gently than the first upper curved portion, the third upper curved portion, and the fourth upper curved portion, as seen in the rear view.

A work machine of the present disclosure includes the cab of the present disclosure.

### Advantageous Effects of Invention

The cab and the work machine of the present disclosure enable reduction of operators' fatigue.

### BRIEF DESCRIPTION OF DRAWINGS

FIG. 1 is a schematic side view of a wheel loader according to an embodiment.

FIG. 2 is a schematic perspective view of a cab according to an embodiment.

FIG. 3 is a partially enlarged top view of the cab according to the embodiment.

FIG. 4 is a partially enlarged top view of the cab according to the embodiment.

FIG. 5 is an enlarged top view of a first control lever and a second control lever of the cab according to the embodiment.

FIG. 6 is an enlarged rear view of the first control lever and the second control lever of the cab according to the embodiment.

FIG. 7 is an enlarged front view of the first control lever and the second control lever of the cab according to the embodiment.

FIG. 8 is an enlarged bottom view of the first control lever and the second control lever of the cab according to the embodiment.

FIG. 9 is an enlarged right side view of the first control lever of the cab according to the embodiment.

FIG. 10 is an enlarged left side view of the first control lever of the cab according to the embodiment.

FIG. 11 is an enlarged right side view of the second control lever of the cab according to the embodiment.

FIG. 12 is an enlarged left side view of the second control lever of the cab according to the embodiment.

FIG. 13 is a partially enlarged top view of a cab according to a modification of the embodiment.

FIG. 14 is a partially enlarged top view of the cab according to the modification of the embodiment.

### DESCRIPTION OF EMBODIMENTS

Embodiments of the present disclosure are described hereinafter in detail with reference to the drawings. In the specification and the drawings, the same components or corresponding components are denoted by the same reference characters, and a description thereof is not repeated herein. In the drawings, any feature(s) may not be shown or simplified for the sake of convenience of description.

### <Configuration of Work Machine 1>

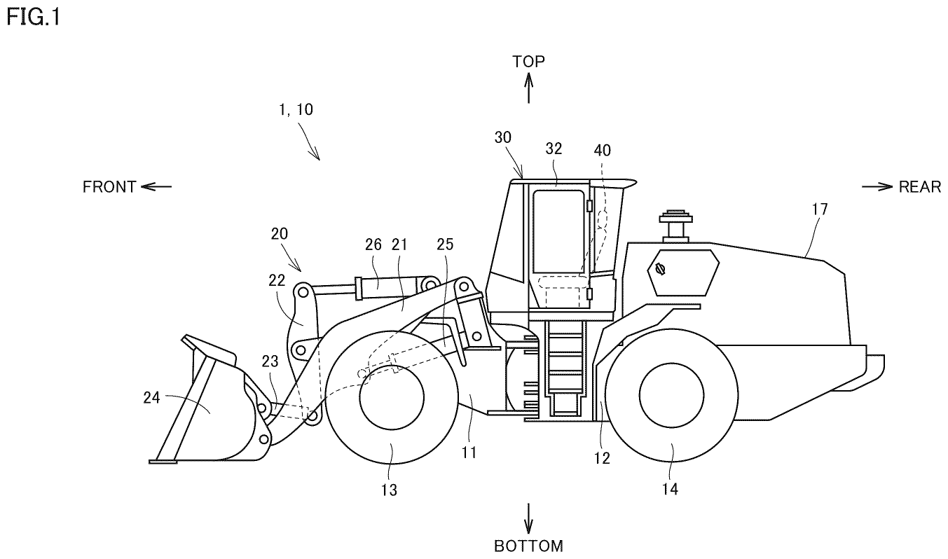

Referring to FIGS. 1 to 7, a configuration of a wheel loader 10 is described as an example of a work machine 1 according to an embodiment.

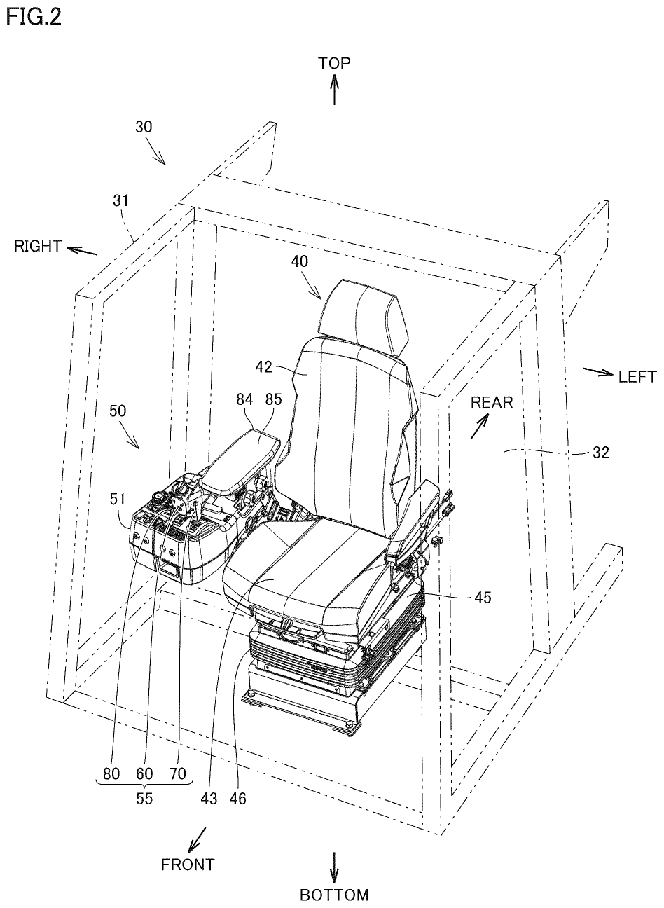

As shown in FIGS. 1 and 2, wheel loader 10 includes a front frame 11, a rear frame 12, a front wheel 13, a rear wheel 14, a work implement 20, a cab (operator's cab) 30, an operator's seat 40, an engine hood 17, a support plate 45, and a suspension mechanism 46.

In the following description, the front-rear direction refers to the front-rear direction of an operator sitting on operator's seat 40 in cab 30. The frontward direction of an operator sitting on operator's seat 40 is the front direction. The backward direction of an operator sitting on operator's seat 40 is the rear direction. The left-right direction (lateral direction) refers to the left-right direction of an operator sitting on operator's seat 40. The right side of an operator sitting on operator's seat 40 with the operator's face directed forward is the right direction. The left side of an operator sitting on operator's seat 40 with the operator's face directed forward is the left direction. The top-bottom direction refers to the top-bottom direction of an operator sitting on operator's seat 40, and is perpendicular to the horizontal direction which includes the front-rear direction and the left-right direction. The foot side of an operator sitting on operator's seat 40 is the lower/bottom side. The upper side of the head of an operator sitting on operator's seat 40 is the upper/top side.

As shown in FIG. 1, front frame 11 and rear frame 12 constitute a vehicle body frame having an articulate structure. Front frame 11 is located frontward of rear frame 12. Front frame 11 is pivotally connected to rear frame 12 by a center pin (not shown). The pivot center of front frame 11 with respect to rear frame 12 is an axis extending in the top-bottom direction. Front frame 11 and rear frame 12 are connected to each other by a steering cylinder (not shown). A pair of left steering cylinder and a right steering cylinder is provided. When the steering cylinders are driven to stretch and contract, front frame 11 pivots to the left/right about the center pin.

As shown in FIG. 1, front wheel 13 and rear wheel 14 are running wheels of wheel loader 10. Front wheel 13 is provided on front frame 11. For example, a pair of front wheels 13 is provided so that the front wheels are located on the left side and the right side of front frame 11 respectively. Rear wheel 14 is provided on rear frame 12. For example, a pair of rear wheels 14 is provided so that the rear wheels are located on the left side and the right side of rear frame 12 respectively.

As shown in FIG. 1, work implement 20 is provided in front frame 11. Work implement 20 includes a boom 21, a bucket 24, a boom cylinder 25, a bell crank 22, a bucket cylinder 26, and a link 23.

As shown in FIG. 1, cab 30 and engine hood 17 are provided in rear frame 12. Cab 30 is located rearward of work implement 20. Engine hood 17 is located rearward of cab 30. A hydraulic oil tank, an engine, a hydraulic pump, an air cleaner, and the like are contained in engine hood 17.

### <Cab 30>

As shown in FIGS. 1 and 2, cab 30 includes a cab body 31, a door 32, operator's seat 40, a console 50, and an armrest 84. Cab body 31 defines an indoor space where an operator enters. Door 32 is provided on a side surface of cab body 31. Door 32 is opened and closed when an operator enters/exits the indoor space of cab 30.

Operator's seat 40 is provided in the indoor space of cab 30. An operator sits on operator's seat 40 and operates wheel loader 10.

### <Operator's Seat 40>

As shown in FIG. 2, operator's seat 40 includes a seat cushion 43 and a seat back 42. Seat cushion 43 is a seat portion on which buttocks of an operator sitting on the seat are rested. Seat back 42 is provided to extend upright from the rear end of seat cushion 43. Seat back 42 is a seat portion on which the back of an operator sitting on the seat is rested.

Support plate 45 is located below seat cushion 43. Support plate 45 has a flat plate shape and extends in the horizontal direction. Suspension mechanism 46 is located below seat cushion 43. Operator's seat 40 is attached to the floor of cab 30 with suspension mechanism 46 interposed therebetween. Suspension mechanism 46 elastically supports operator's seat 40.

### <Console 50>

As shown in FIGS. 2 to 4, console 50 is located laterally of operator's seat 40. In the present embodiment, console 50 is provided on the right side of operator's seat 40. Console 50 is fixed to support plate 45 with an intermediate bracket (not shown) interposed therebetween.

Console 50 includes a console housing 51 and an operation unit 55. Console housing 51 is separated from seat cushion 43 in the left-right direction. Console housing 51 has an upper surface 52. Upper surface 52 is located higher than seat cushion 43. Upper surface 52 has an elongate shape of which front-rear direction is the longitudinal direction and of which left-right direction is the widthwise direction. Console 50 includes a front portion 53. Front portion 53 is a frontward portion of console 50. Front portion 53 is located frontward of armrest 84.

### <Operation Unit 55>

As shown in FIGS. 2 to 4, operation unit 55 is provided in console housing 51. Operation unit 55 is provided on upper surface 52. Operation unit 55 is located closer to the front end of upper surface 52 than to the rear end of upper surface 52 in the front-rear direction. Operation unit 55 is provided in front portion 53. Operation unit 55 controls operation of wheel loader 10 by being operated by an operator.

Operation unit 55 includes a first control lever 60, a second control lever 70, and a third control switch 80. Operation unit 55 may further include various control switches.

First control lever 60 and second control lever 70 are provided in a region included in upper surface 52 and relatively closer to operator's seat 40 (this region is a left region of upper surface 52 in the present embodiment). First control lever 60 and second control lever 70 are provided in a region included in upper surface 52 and relatively closer to operator's seat 40 in the left-right direction. Second control lever 70 is located between operator's seat 40 and first control lever 60 in the left-right direction. In the left-right direction, first control lever 60 is located relatively further from operator's seat 40 than second control lever 70 is. First control lever 60 and second control lever 70 are movable in the front-rear direction.

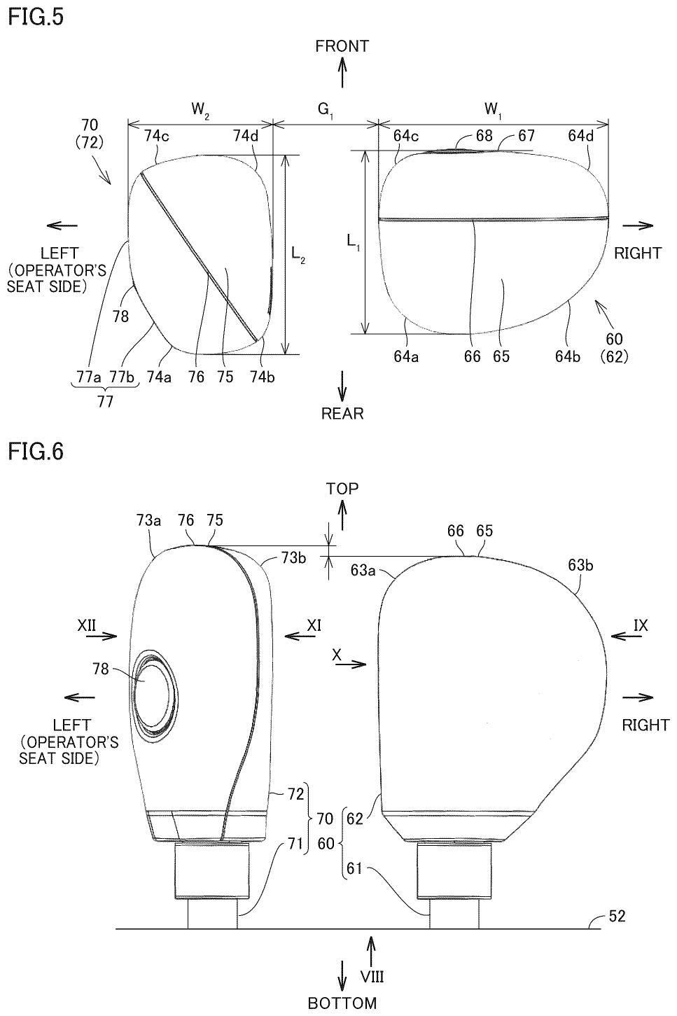

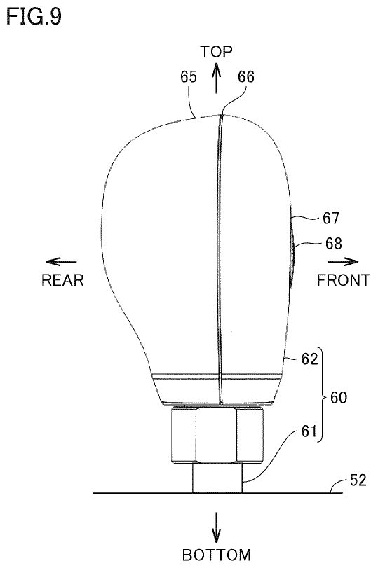

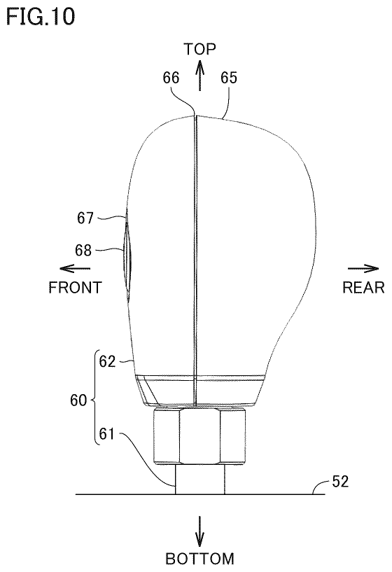

As shown in FIGS. 6, 7, 9, and 10, first control lever 60 includes a first shaft 61 and a first knob 62. First shaft 61 protrudes from upper surface 52 of console 50. First knob 62 is provided on the upper end of first shaft 61. As shown in FIGS. 5 to 7, first knob 62 has a first upper surface 65 as seen in a top view. First upper surface 65 is a portion that is included in the surface of first knob 62 and visible in the top view. First upper surface 65 has a first top 66 of first knob 62.

As shown in FIG. 5, first knob 62 includes, as seen in a top view, a first rear curved portion 64a located on the operator's seat 40 side, a second rear curved portion 64b located on the opposite side to the operator's seat 40 side, a first front curved portion 64c located on the operator's seat 40 side, and a second front curved portion 64d located on the opposite side to the operator's seat 40 side. As seen in the top view, second rear curved portion 64b is curved more gently than first rear curved portion 64a. As seen in the top view, second front curved portion 64d is curved more gently than first front curved portion 64c. As seen in the top view, second rear curved portion 64b is curved more gently than second front curved portion 64d.

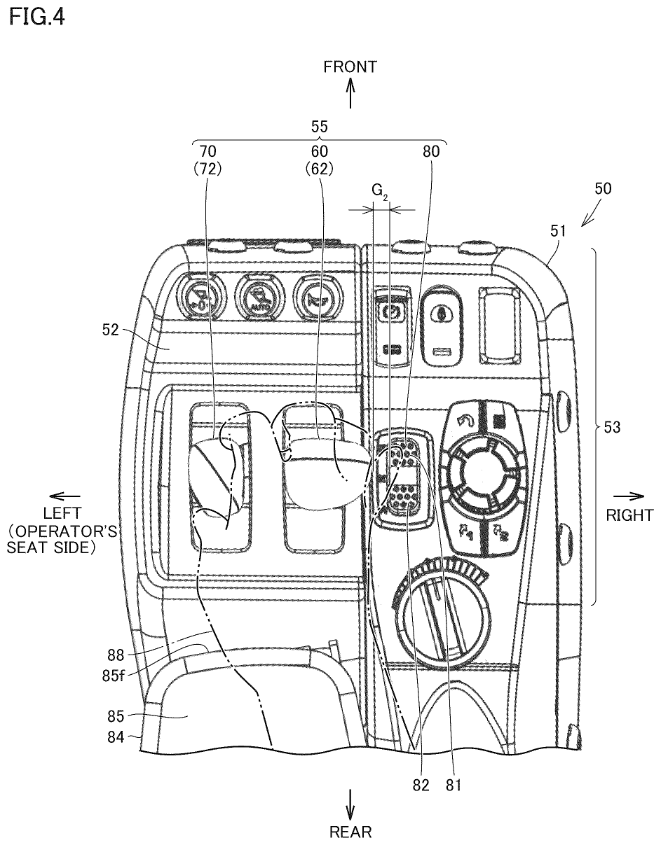

As shown in FIG. 6, first knob 62 includes a first upper curved portion 63a on the operator's seat 40 side and a second upper curved portion 63b on the opposite side to the operator's seat 40 side, as seen in a rear view. As seen in the rear view, second upper curved portion 63b is curved more gently than first upper curved portion 63a. As shown in FIG. 4, the middle finger and the ring finger of a hand 88 of an operator as well as the base of the middle and ring fingers of the palm of hand 88 are rested on first upper surface 65, or second upper curved portion 63b, or both of first upper surface 65 and second upper curved portion 63b. With the middle and ring fingers of hand 88 of the operator as well as the base of the middle and ring fingers of the palm of hand 88 rested on first upper surface 65, or second upper curved portion 63b, or both of first upper surface 65 and second upper curved portion 63b, the palm of hand 88 and the wrist of the operator can be moved in the front-rear direction to operate first control lever 60. First control lever 60 is, for example, a boom control lever for controlling operation of boom 21.

As shown in FIGS. 5 and 7 to 10, a front portion of first knob 62 is provided with a first control switch 68. Specifically, first knob 62 has a front side surface 67, and first control switch 68 is provided on front side surface 67 of first knob 62. Front side surface 67 of first knob 62 is a portion that is included in the surface of first knob 62 and visible in a front view. As seen in the front view, first control switch 68 may be provided, for example, in a central region of front side surface 67 of first knob 62. As shown in FIG. 4, first control switch 68 may be operated by the ball of the middle finger of the operator's hand 88. First control switch 68 is, for example, a push button type switch.

First control switch 68 is, for example, a traction control switch. A level of traction control is selected by means of the traction control switch. When the traction control switch is pressed while the traction control is in the ON state, the traction control is cancelled so that the traction control enters the OFF state. Thus, the maximum traction force is increased. The traction control switch is used for increasing the maximum traction force, for raising work and the like. When the traction control switch is pressed again, the traction control returns to the ON state. When wheel loader 10 is moving backward, the traction control is kept in the OFF state and will not be switched even when the traction control switch is pressed.

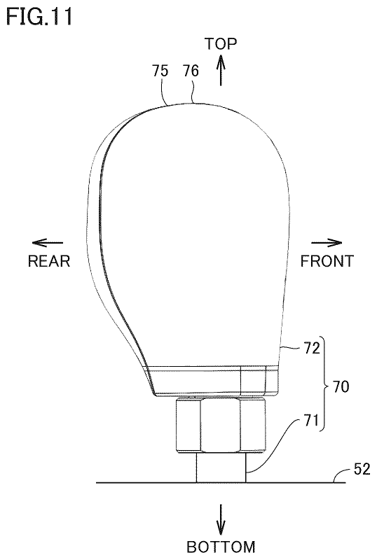

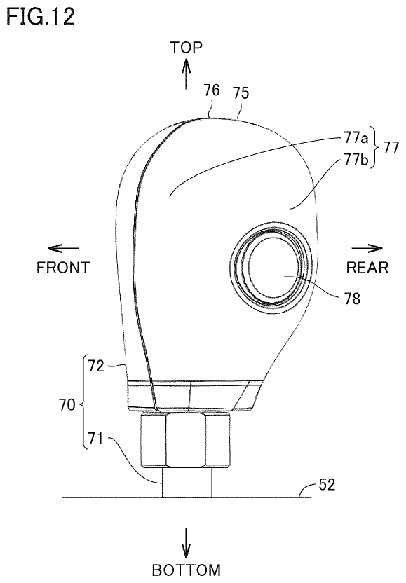

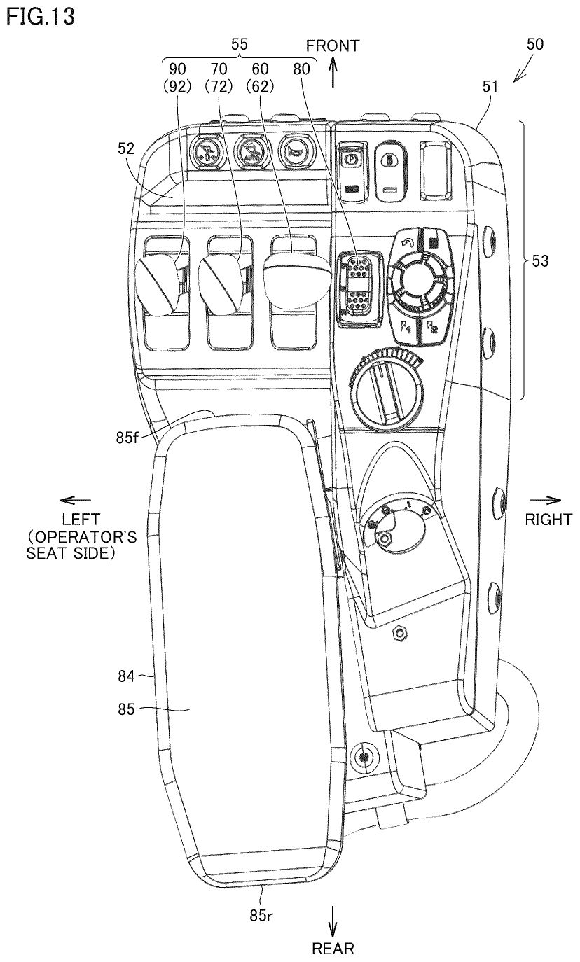

As shown in FIGS. 6, 7, 11, and 12, second control lever 70 includes a second shaft 71 and a second knob 72. Second shaft 71 protrudes from upper surface 52 of console 50. Second knob 72 is provided on the upper end of second shaft 71. As shown in FIGS. 5 to 7, second knob 72 has a second upper surface 75 as seen in a top view. Second upper surface 75 is a portion that is included in the surface of second knob 72 and visible in the top view. Second upper surface 75 has a second top 76 of second knob 72.

As shown in FIG. 5, second knob 72 includes, as seen in a top view, a third rear curved portion 74a located on the operator's seat 40 side, a fourth rear curved portion 74b located on the opposite side to operator's seat 40, a third front curved portion 74c on the operator's seat 40 side, and a fourth front curved portion 74d on the opposite side to the operator's seat 40 side. Second knob 72 has a side surface 77 on the operator's seat 40 side. Side surface 77 from second upper surface 75 is a portion included in the surface of second knob 72 and visible in a plan view as seen from the operator's seat 40 side (a plan view as seen from the left in the present embodiment). As shown in FIG. 5, side surface 77 includes a front-side portion 77a and a rear-side portion 77b. As seen in the top view, front-side portion 77a extends in the front-rear direction. As seen in the top view, rear-side portion 77b extends rearward from front-side portion 77a toward the first control lever (rightward in the present embodiment).

As shown in FIG. 6, second knob 72 includes, as seen in a rear view, a third upper curved portion 73a located on the operator's seat 40 side, and a fourth upper curved portion 73b located on the opposite side to the operator's seat 40 side. As shown in FIG. 4, the thumb, or the index finger, or both of the thumb and the index finger of operator's hand 88 can be used to move second control lever 70 in the front-rear direction and thereby operate second control lever 70. Second control lever 70 is, for example, a bucket control lever for controlling operation of bucket 24.

As shown in FIGS. 5, 6, 8, and 12, a portion included in second knob 72 and located on the operator's seat 40 side is provided with a second control switch 78. Second control switch 78 is provided on side surface 77 of second knob 72. Specifically, second control switch 78 is provided in rear-side portion 77b of side surface 77. As shown in FIG. 4, second control switch 78 may be operated by the ball of the thumb of operator's hand 88. Second control switch 78 is, for example, a push button type switch.

Second control switch 78 is, for example, a bucket control switch. The bucket control switch has the following two functions. The first function of the bucket control switch is a bucket positioner function. When the bucket control switch is pressed, bucket 24 is moved to a set position. The second function of the bucket control switch is an automatic bucket swing function. When the bucket control switch is kept pressed for a first time (e.g., one second or more), bucket 24 is kept swung for a second time (e.g., six seconds) without the need to operate second control lever 70 (bucket control lever). The second time is longer than the first time.

As shown in FIG. 5, as seen in a top view, second rear curved portion 64b is curved more gently than first rear curved portion 64a, first front curved portion 64c, second front curved portion 64d, third rear curved portion 74a, fourth rear curved portion 74b, third front curved portion 74c, and fourth front curved portion 74d. As seen in the top view, width W₁ of first knob 62 is larger than width W₂ of second knob 72. In this specification, width W₁ of first knob 62 is the measurement of first knob 62 in the left-right direction as seen in the top view. Width W₂ of second knob 72 is the measurement of second knob 72 in the left-right direction as seen in the top view. Width W₁ of first knob 62 is, for example, 1.4 times or more and 1.8 times or less as large as width W₂ of second knob 72. Width W₁ of first knob 62 is, for example, 45 mm or more and 60 mm or less. Width W₂ of second knob 72 is, for example, 30 mm or more and 36 mm or less.

As seen in the top view, length L₁ of first knob 62 is smaller than length L₂ of second knob 72. In this specification, length L₁ of first knob 62 is the measurement of first knob 62 in the front-rear direction as seen in the top view. Length L₂ of second knob 72 is the measurement of second knob 72 in the front-rear direction as seen in the top view. Width W₁ of first knob 62 is larger than length L₁ of first knob 62. Length L₂ of second knob 72 is larger than width W₂ of second knob 72.

As shown in FIG. 5, as seen in the top view, distance G₁ between first control lever 60 and second control lever 70 is smaller than width W₁ of first knob 62. Distance G₁ may be equal to or less than 0.6 times as large as width W₁ or equal to or less than 0.5 times as large as width W₁. As seen in the top view, distance G₁ is smaller than width W₂ of second knob 72. Distance G₁ may be equal to or less than 0.9 times as large as width W₂, or may be equal to or less than 0.8 times as large as width W₂. Distance G₁ may be equal to or greater than 0.3 times as large as width W₂, may be equal to or greater than 0.5 times as large as width W₂, or may be equal to or greater than 0.6 times as large as width W₂. Distance G₁ may be 32 mm or less. Distance G₁ may be 10 mm or more, 15 mm or more, or 20 mm or more. As seen in the top view, distance G₁ is smaller than length L₁ of first knob 62. As seen in the top view, distance G₁ is smaller than length L₂ of second knob 72.

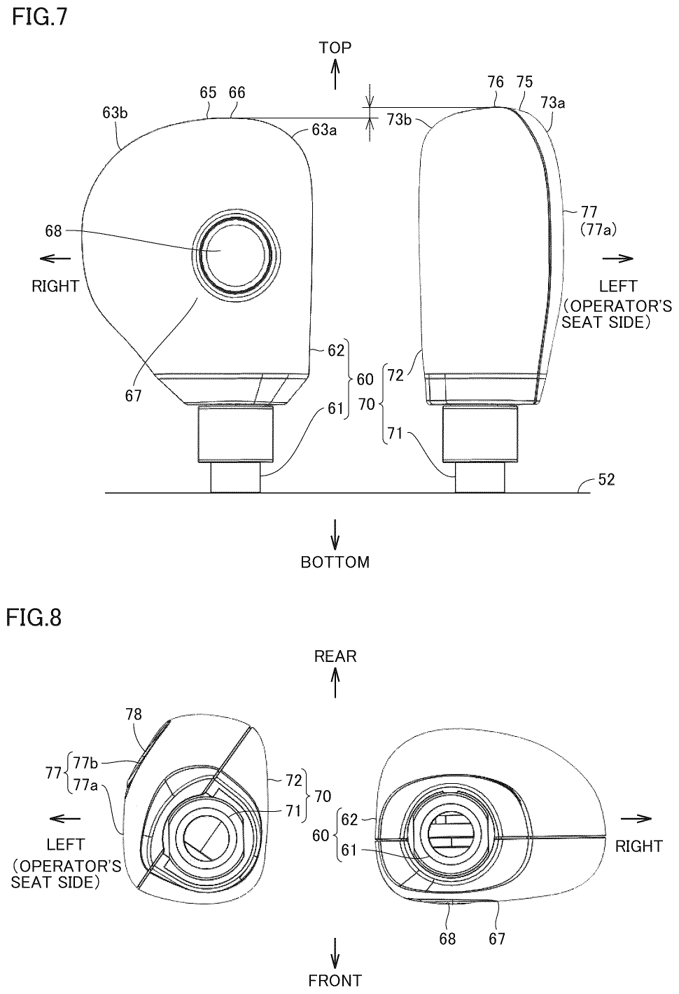

As shown in FIG. 6, as seen in a rear view, second upper curved portion 63b is curved more gently than first upper curved portion 63a, third upper curved portion 73a, and fourth upper curved portion 73b. As shown in FIGS. 6 and 7, first top 66 of first knob 62 is lower than second top 76 of second knob 72.

As shown in FIG. 2 to FIG. 4, third control switch 80 is provided in a region that is included in upper surface 52 of console 50 and located relatively further from operator's seat 40 (the region is a right region of upper surface 52 in the present embodiment). As seen in a top view, distance G₂ (see FIG. 4) between first knob 62 and third control switch 80 is smaller than distance G₁ (see FIG. 5) between first knob 62 and second knob 72. Distance G₂ may be equal to or less than 0.7 times as large as distance G₁, equal to or less than 0.6 times as large as distance G₁, or equal to or less than 0.5 times as large as distance G₁. Third control switch 80 is, for example, a forward-backward switch of work machine 1. When a front part 81 of third control switch 80 is pressed, work machine 1 moves forward. When a rear part 82 of third control switch 80 is pressed, work machine 1 moves backward. When the third control switch is in a neutral state, work machine 1 does not move.

### <Armrest 84>

As shown in FIGS. 2 to 4, armrest 84 is located laterally of operator's seat 40. In the present embodiment, armrest 84 is located on the right side of operator's seat 40. Armrest 84 is attached to console 50. Armrest 84 is located above console 50 (console housing 51). Regarding armrest 84, as seen in a top view, at least a part of armrest 84 overlaps upper surface 52 of console housing 51. Armrest 84 is located rearward of first control lever 60 and second control lever 70.

As shown in FIGS. 2 to 4, armrest 84 has an upper surface 85. Upper surface 85 extends in the horizontal direction. The operator's forearm and elbow are rested on upper surface 85. Upper surface 85 is located higher than seat cushion 43. Upper surface 85 is located higher than upper surface 52 of console housing 51. Upper surface 85 has a substantially rectangular shape of which front-rear direction is the longitudinal direction and of which left-right direction is the widthwise direction.

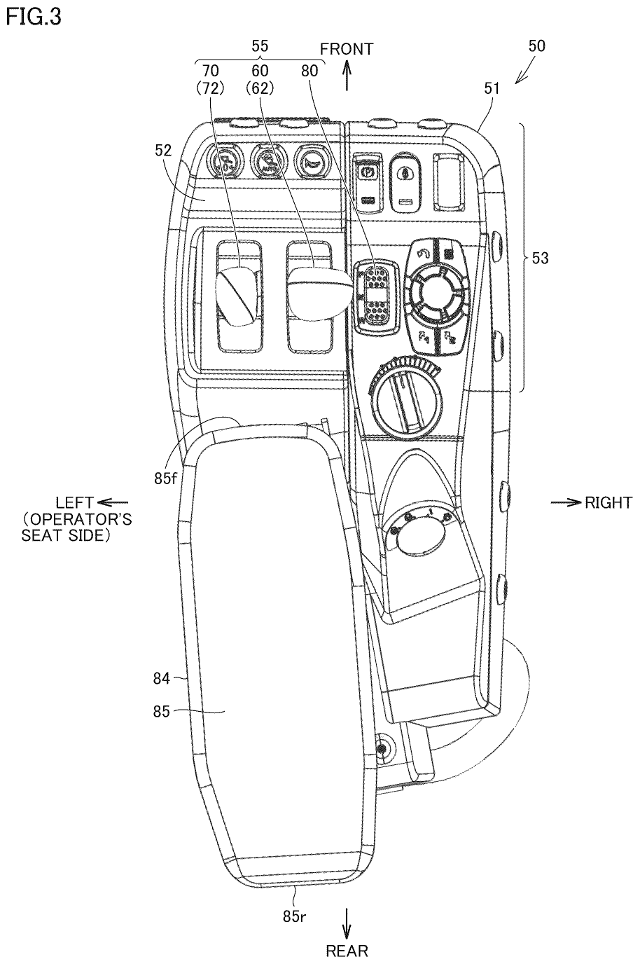

As shown in FIGS. 3 and 4, upper surface 85 has a front end portion 85f and a rear end portion 85r. Front end portion 85f corresponds to the shorter side located on the front side, among the four sides of upper surface 85 having the substantially rectangular shape. Rear end portion 85r corresponds to the shorter side located on the rear side, among the four sides of upper surface 85 having the substantially rectangular shape. Front end portion 85f is located laterally of seat cushion 43 as seen in a top view. Rear end portion 85r is located laterally of seat back 42 as seen in the top view.

### (Modification)

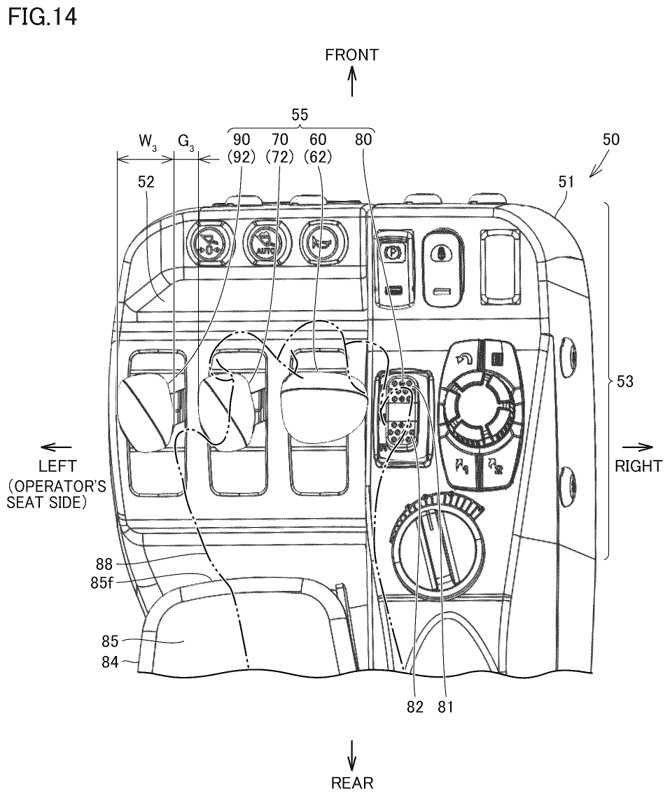

Referring to FIGS. 13 and 14, a modification of the present embodiment is described.

As shown in FIGS. 13 and 14, operation unit 55 further includes a third control lever 90. Third control lever 90 is provided as an option in operation unit 55. Third control lever 90 is provided in a region that is included in upper surface 52 and located relatively closer to operator's seat 40 (the region is a left region of upper surface 52 in the present embodiment). Third control lever 90 is provided in the region that is included in upper surface 52 and located relatively closer to operator's seat 40 in the left-right direction. Third control lever 90 is located between operator's seat 40 and second control lever 70 in the left-right direction. Third control lever 90 is movable in the front-rear direction.

Third control lever 90 is configured similarly to second control lever 70. Specifically, third control lever 90 includes a third shaft (not shown) and a third knob 92. The third shaft protrudes from upper surface 52 of console 50. Third knob 92 is provided on the upper end of the third shaft. Third knob 92 has a shape similar to that of second knob 72. While third control lever 90 may be provided with a control switch corresponding to second control switch 78, this control switch may not function. Third control lever 90 may not be provided with a control switch corresponding to second control switch 78.

As shown in FIG. 14, as seen in a top view, distance G₃ between second control lever 70 and third control lever 90 is smaller than width W₃ of third knob 92. As seem in the top view, distance G₃ is smaller than width W₁ (see FIG. 5) of first knob 62. As seen in the top view, distance G₃ is smaller than width W₂ (see FIG. 5) of second knob 72. As seen in the top view, distance G₃ is equal to or smaller than distance G₁ (see FIG. 5) between first control lever 60 and second control lever 70. As seen in the top view, distance G₂ (see FIG. 4) between first knob 62 and third control switch 80 is smaller than distance G₃.

As shown in FIG. 14, in the modification of the present embodiment as well, hand 88 of an operator is usually rested on first control lever 60 and second control lever 70, as in the present embodiment. When the operator is to operate third control lever 90, the thumb and the index finger of the operator's hand 88 are moved or operator's hand 88 is shifted toward operator's seat 40, to bring the thumb and the index finger of operator's hand 88 into contact with third control lever 90. Third control lever 90 can be operated by moving third control lever 90 in the front-rear direction, using the thumb, or the index finger, or both the thumb and the index finger of operator's hand 88.

Work machine 1 of the present disclosure is not limited to wheel loader 10, but may be any of various work machines such as bulldozer.

Advantageous effects of cab 30 and work machine 1 of the present embodiment are described.

Cab 30 in the present embodiment includes operator's seat 40 and console 50. Console 50 includes operation unit 55 and is located laterally of operator's seat 40. Operation unit 55 includes first control lever 60 and second control lever 70. Second control lever 70 is located between operator's seat 40 and first control lever 60 in a left-right direction. First control lever 60 includes first knob 62. Second control lever 70 includes second knob 72. First knob 62 has width W₁ larger than width W₂ of second knob 72 as seen in a top view.

Therefore, the middle finger and the ring finger of hand 88 of an operator as well as the base of the middle and ring fingers of the palm of hand 88 may be rested on first knob 62. When first control lever 60 and second control lever 70 are not operated, hand 88 may be rested on first knob 62. First knob 62 supports the weight of hand 88. When operating first control lever 60 and second control lever 70, the operator can operate first control lever 60 and second control lever 70 with operator's hand 88 rested on first knob 62. Movement of operator's hand 88 required to operate first control lever 60 and second control lever 70 can be reduced. With cab 30 of the present embodiment, operator's fatigue can be reduced.

In cab 30 of the present embodiment, first knob 62 includes: first upper curved portion 63a located on the operator's seat 40 side, which is a side located laterally of the operator's seat; and second upper curved portion 63b located on an opposite side to the operator's seat 40 side, as seen in a rear view. Second upper curved portion 63b is curved more gently than first upper curved portion 63a as seen in the rear view.

With second upper curved portion 63b curved gently, an operator can rest hand 88 on first knob 62 in a stable state.

In cab 30 of the present embodiment, second knob 72 includes third upper curved portion 73a located on the operator's seat 40 side and fourth upper curved portion 73b located on the opposite side to the operator's seat 40 side, as seen in the rear view. Second upper curved portion 63b is curved more gently than third upper curved portion 73a and fourth upper curved portion 73b, as seen in the rear view.

With second upper curved portion 63b curved gently, an operator can rest hand 88 on first knob 62 in a stable state.

In cab 30 of the present embodiment, first top 66 of first knob 62 is lower than second top 76 of second knob 72.

Thus, when first control lever 60 and second control lever 70 are not operated, hand 88 can be rested on first knob 62 in a more natural posture. With cab 30 of the present embodiment, operator's fatigue can be reduced.

In cab 30 of the present embodiment, first control lever 60 and second control lever 70 are movable in the front-rear direction.

With operator's hand 88 rested on first knob 62, the palm of operator's hand 88 and the wrist of the operator can be moved in the front-rear direction, so that the operator can operate first control lever 60 and second control lever 70. With cab 30 of the present embodiment, operator's fatigue can be reduced.

In cab 30 of the present embodiment, a front portion (front side surface 67 for example) of first knob 62 is provided with first control switch 68.

Therefore, with operator's hand 88 rested on first knob 62, first control switch 68 can be operated by the middle finger of hand 88. With cab 30 of the present embodiment, operator's fatigue can be reduced.

In cab 30 of the present embodiment, a portion included in second knob 72 and located laterally of operator's seat 40 is provided with second control switch 78.

Therefore, with operator's hand 88 rested on first knob 62, second control switch 78 can be operated by the thumb of hand 88. With cab 30 of the present embodiment, operator's fatigue can be reduced.

In cab 30 of the present embodiment, operation unit 55 includes third control switch 80. Distance G₂ between first knob 62 and third control switch 80 is smaller than distance G₁ between first knob 62 and second knob 72, as seen in the top view.

With operator's hand 88 rested on first knob 62, third control switch 80 can be operated by the little finger of hand 88. With cab 30 of the present embodiment, operator's fatigue can be reduced.

In cab 30 of the present embodiment, distance G₂ between first control lever 60 and second control lever 70 is smaller than width W₁ of first knob 62.

Movement of operator's hand 88 required to operate first control lever 60 and second control lever 70 can be reduced. With cab 30 of the present embodiment, operator's fatigue can be reduced.

In cab 30 of the present embodiment, first control lever 60 is a boom control lever. Second control lever 70 is a bucket control lever.

When first control lever 60 and second control lever 70 are not operated, hand 88 may be rested on first knob 62. First knob 62 supports the weight of hand 88. Further, when first control lever 60 and second control lever 70 are operated, movement of operator's hand 88 required to operate first control lever 60 and second control lever 70 can be reduced. With cab 30 of the present embodiment, operator's fatigue can be reduced.

Work machine 1 of the present embodiment includes cab 30 of the present embodiment.

When first control lever 60 and second control lever 70 are not operated, hand 88 may be rested on first knob 62. First knob 62 supports the weight of hand 88. Further, when first control lever 60 and second control lever 70 are operated, movement of operator's hand 88 required to operate first control lever 60 and second control lever 70 can be reduced. With work machine 1 of the present embodiment, operator's fatigue can be reduced.

It should be construed that embodiments disclosed herein are given by way of illustration in all respects, not by way of limitation. It is intended that the scope of the present disclosure is defined by claims, not by the description above, and encompasses all variations equivalent in meaning and scope to the claims.

### REFERENCE SIGNS LIST

1 work machine; 10 wheel loader; 11 front frame; 12 rear frame; 13 front wheel; 14 rear wheel; 17 engine hood; 20 work implement; 21 boom; 22 bell crank; 23 link; 24 bucket; 25 boom cylinder; 26 bucket cylinder; 30 cab; 31 cab body; 32 door; 40 operator's seat; 42 seat back; 43 seat cushion; 45 support plate; 46 suspension mechanism; 50 console; 51 console housing; 52 upper surface; 53 front portion; 55 operation unit; 60 first control lever; 61 first shaft; 62 first knob; 63a first upper curved portion; 63b second upper curved portion; 64a first rear curved portion; 64b second rear curved portion; 64c first front curved portion; 64d second front curved portion; 65 first upper surface; 66 first top; 67 front side surface; 68 first control switch; 70 second control lever; 71 second shaft; 72 second knob; 73a third upper curved portion; 73b fourth upper curved portion; 74a third rear curved portion; 74b fourth rear curved portion; 74c third front curved portion; 74d fourth front curved portion; 75 second upper surface; 76 second top; 77 side surface; 77a front-side portion; 77b rear-side portion; 78 second control switch; 80 third control switch; 81 front part; 82 rear part; 84 armrest; 85 upper surface; 85f front end portion; 85r rear end portion; 88 hand; 90 third control lever; 92 third knob.

1: A cab comprising:
an operator's seat; and
a console including an operation unit and being located laterally of the operator's seat, wherein
the operation unit includes a first control lever and a second control lever,
the second control lever is located between the operator's seat and the first control lever in a left-right direction,
the first control lever includes a first knob,
the second control lever includes a second knob,
the first knob has a width larger than a width of the second knob as seen in a top view,
the width of the first knob is a measurement of the first knob in the left-right direction as seen in the top view, and
the width of the second knob is a measurement of the second knob in the left-right direction as seen in the top view.

2: The cab according to claim 1, wherein
the first knob includes: a first upper curved portion located on an operator's seat side, which is a side located laterally of the operator's seat; and a second upper curved portion located on an opposite side to the operator's seat side, as seen in a rear view,
the second upper curved portion is curved more gently than the first upper curved portion as seen in the rear view.

3: The cab according to claim 2, wherein
the second knob includes a third upper curved portion located on the operator's seat side and a fourth upper curved portion located on the opposite side to the operator's seat side, as seen in the rear view, and
the second upper curved portion is curved more gently than the third upper curved portion and the fourth upper curved portion, as seen in the rear view.

4: The cab according to claim 1, wherein a top of the first knob is lower than a top of the second knob.

5: The cab according to claim 1, wherein the first control lever and the second control lever are movable in a front-rear direction.

6: The cab according to claim 1, wherein a front portion of the first knob is provided with a first control switch.

7: The cab according to claim 1, wherein a portion included in the second knob and located laterally of the operator's seat is provided with a second control switch.

8: The cab according to claim 1, wherein
the operation unit includes a third control switch, and
a distance between the first knob and the third control switch is smaller than a distance between the first knob and the second knob, as seen in the top view.

9: The cab according to claim 1, wherein a distance between the first control lever and the second control lever is smaller than the width of the first knob.

10: The cab according to claim 1, wherein
the first control lever is a boom control lever, and
the second control lever is a bucket control lever.

11: A work machine comprising the cab according to claim 1.
